(19) United States
(12) Patent Application Publication
(10) Pub. No.: US 2012/0014611 A1
(43) Pub. Date: Jan. 19, 2012

(54) SYSTEM AND METHOD FOR DETERMINING PHASE RETRIEVAL SAMPLING FROM THE MODULATION TRANSFER FUNCTION

(76) Inventor: BRUCE H. DEAN, New Market, MD (US)

(21) Appl. No.: 12/839,125

(22) Filed: Jul. 19, 2010

(51) Int. Cl. G06K 9/46

(52) U.S. Cl. 382/207

(57) ABSTRACT

Disclosed herein are systems, methods, and non-transitory computer-readable storage media for determining phase of an optical system. A system practicing the method performs an analysis of image data of a distant object, wherein the image data is received via an optical system. The system derives at least one parameter of the optical system based on the analysis, and retrieves a phase of the optical system based on the at least one parameter. The parameter can be a ratio Q representing a ration of wavelength times a focal ratio divided by pixel spacing. The image data can be a series of still images. The analysis of the image data can be based on a user input indicating, for example, a position and/or a region in the image data. The image data can be in focus and/or out of focus. In one aspect, slightly out of focus image data is more informative.

### BACKGROUND

1. Technical Field

The present disclosure relates to determining phase of an optical system and more specifically to determining the phase based on an image captured via the optical system.

2. Introduction

Optical systems are very sensitive to aberrations, imperfections, and misalignments, especially very complicated optical systems having many elements. Optical systems can get out of alignment due to a number of reasons, such as jostling a space telescope during launch. It is difficult, or sometimes impossible, to accurately measure each element of the optical system to determine how to best correct for these errors.

Errors in optical system parameters propagate to errors in the retrieved phase. In applications such as the commissioning of the James Webb Space Telescope (JWST), these phase errors propagate to positioning and alignment errors of the segmented primary mirror as well as to errors in aligning the secondary mirror. Previous approaches often included errors in these parameters which propagated as errors in the retrieved phase, and contributed to systematic errors. These phase errors propagate to positioning and alignment errors of the segmented primary mirror as well as to errors in aligning the secondary mirror during commissioning.

One approach to resolve this issue requires the insertion of a non-redundant aperture into the pupil plane, which must then be removed after the data collection is complete. However, this approach has a major disadvantage when pupil access is not readily accessible, such as a remote telescope. This approach is completely unworkable in a space deployed optical system such as the JWST where no pupil access is available. Further, implementing such a system in a cryo-vac test chamber can be expensive and require additional cryogenic cycles for the insertion and removal of the non-redundant aperture at each optical imaging configuration. Accordingly, what is needed in the art is an improved way to detect and correct errors and imperfections in optical systems.

### SUMMARY

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Using image-based phase retrieval to characterize an optical system requires an accurate characterization of system parameters such as detector pixel-size, pixel-spacing, imaging wavelength, focal ratio, diversity function, and the pupil transmission function. In typical applications, some of these parameters are known quite accurately such as the pixel size and wavelength, but other quantities such as the focal length, sampled pupil diameter, must often be derived from a model which rarely matches the as-built values of the physical system. Direct measurement of these parameters is often complicated by limited access to measurement points within the optical system. For example, some situations require a simple means to assess differences between ambient and in-situ cryogenic performance.

The approach disclosed herein is an image-based technique for determining Q, which can be used to determine the plate scale p from the optical system cutoff defined by the system's modulation transfer function (MTF). Disclosed are systems, methods, and non-transitory computer-readable storage media for determining phase of an optical system. A system practicing the method performs an analysis of image data of a distant object, wherein the image data is received via an optical system. The system derives at least one parameter of the optical system based on the analysis, and retrieves a phase of the optical system based on the at least one parameter. The parameter can be a ratio Q representing a ratio of wavelength times a focal ratio divided by pixel spacing. The image data can be a series of still images. The analysis of the image data can be based on a user input indicating, for example, a position and/or a region in the image data. The image data can be in focus and/or out of focus. In one aspect, slightly out of focus image data is more informative. The system can derive one or more parameter of the optical system based on a diversity function. The system can generate an optical model based on an optical transfer function. The system can also enhance contrast of the image data by a deconvolution function to more clearly show a cutoff frequency.

phase retrieval can not only describe how and why an optical system is not optimally configured, but can provide feedback describing how to update the optical system to correct those errors.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates an example system embodiment;

FIG. 2A illustrates an exemplary simple lens-based optical system;

FIG. 2B illustrates an exemplary simple mirror-based optical system;

FIG. 3A illustrates a first example image received from an optical system;

FIG. 3B illustrates a second example image received from an optical system;

FIGS. 4A-4C illustrate a group of example images showing different phase retrieval results for various optical systems; and

FIG. 5 illustrates an example method embodiment.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

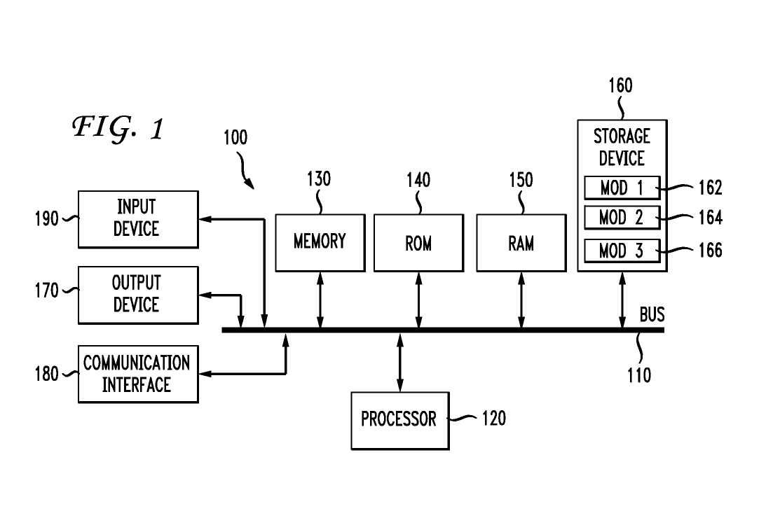

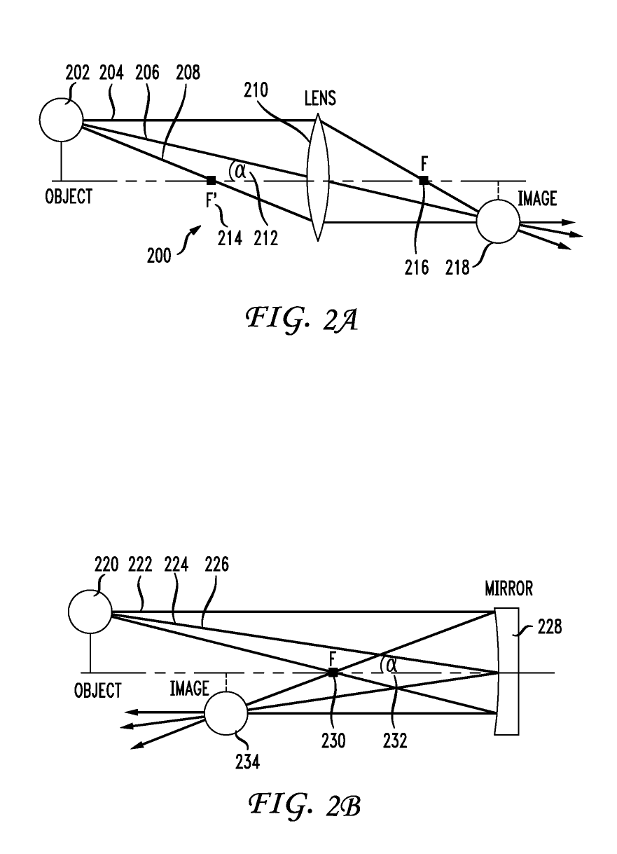

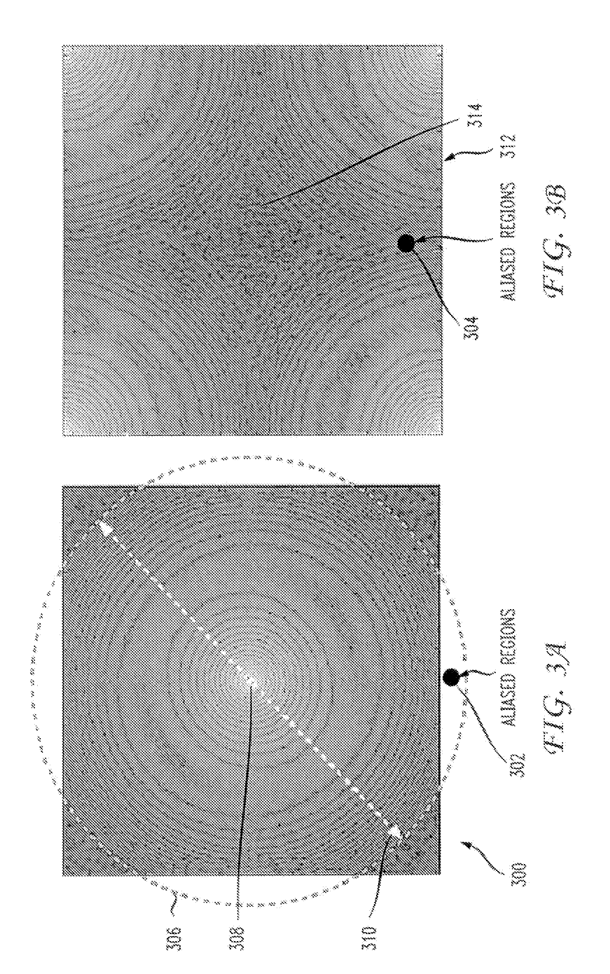

The present disclosure addresses the need in the art for determining characteristics of optical systems which may be inaccessible or difficult to access. Disclosed herein is a technique to accurately determine several optical system parameters simultaneously by using an image based measurement technique. The required data is point-source images collected at the focal plane, such as with a science camera or other CCD array. The data collected for focus-diverse phase retrieval experiments can be used as input, but in-focus images are also suitable as input. A system, method and non-transitory computer-readable media are disclosed which can determine the phase and/or other optical characteristics of an optical system. A discussion of a basic general purpose system or computing device as shown in FIG. 1 will be discussed which can be employed to practice the concepts disclosed herein. Following the discussion of FIG. 1, the disclosure turns to a brief description of two exemplary simple optical systems as shown in FIGS. 2A and 2B and sample image data received from optical systems. A more detailed description of the method embodiment will then follow.

As a brief overview, the approach described herein can characterize optical system parameters in order to perform accurate phase retrieval of the system. Accurate phase retrieval provides feedback based on the actual optical system configuration instead of a flawed model representing the optical system configuration. Models can be flawed due to inadequate measurements, insufficiently accurate measurements, erroneous or incomplete understanding of the optical system, shifting of optical elements during transit, and so forth. This feedback can then be used to tune or focus the optical system more precisely.

This approach is an image-based technique for determining Q (and thus the plate scale p) from the optical system cutoff defined by an optical system's modulation transfer function (MTF). For example, in many typical applications some parameters such as pixel size and wavelength are known quite accurately, but other quantities such as the focal length or sampled pupil diameter must often be derived based on a model which rarely matches the as-built values. However, by directly measuring the optical system cut-off frequency, the system can directly calculate Q, or the image sampling parameter, from the image-based data. Q is equal to the data sampling frequency divided by the cut-off frequency (or band-limit), which is equal to

$$\frac{λ {f}_{\#}}{Δ x}$$

(where λ is the optical system wavelength and f_{b} is the focal ratio of the optical system), which is equal to

$$\frac{λ}{p \cdot D} ,$$

where p is the plate scale, or the ratio of the angular distance between two stars to the linear distance between their images on a photographic plate, in radians. These and other variations shall be discussed herein as the various embodiments are set forth. The disclosure now turns to the exemplary computing device shown in FIG. 1.

With reference to FIG. 1, an exemplary system 100 includes a general-purpose computing device 100, including a processing unit (CPU or processor) 120 and a system bus 110 that couples various system components including the system memory 130 such as read only memory (ROM) 140 and random access memory (RAM) 150 to the processor 120. The system 100 can include a cache 122 of high speed memory connected directly with, in close proximity to, or integrated as part of the processor 120. The system 100 copies data from the memory 130 and/or the storage device 160 to the cache 122 for quick access by the processor 120. In this way, the cache 122 provides a performance boost that avoids processor 120 delays while waiting for data. These and other modules can be configured to control the processor 120 to perform various actions. Other system memory 130 may be available for use as well. The memory 130 can include multiple different types of memory with different performance characteristics. It can be appreciated that the disclosure may operate on a computing device 100 with more than one processor 120 or on a group or cluster of computing devices networked together to provide greater processing capability. The processor 120 can include any general purpose processor and a hardware module or software module, such as module 1 162, module 2 164, and module 3 166 stored in storage device 160, configured to control the processor 120 as well as a special-purpose processor where software instructions are incorporated into the actual processor design. The processor 120 may essentially be a completely self-contained computing system, containing multiple cores or processors, a bus, memory controller, cache, etc. A multi-core processor may be symmetric or asymmetric.

The system bus 110 may be any of several types of bus structures including a memory bus or memory controller, a peripheral bus, and a local bus using any of a variety of bus architectures. A basic input/output (BIOS) stored in ROM 140 or the like, may provide the basic routine that helps to transfer information between elements within the computing device 100, such as during start-up. The computing device 100 further includes storage devices 160 such as a hard disk drive, a magnetic disk drive, an optical disk drive, tape drive or the like. The storage device 160 can include software modules 162, 164, 166 for controlling the processor 120. Other hardware or software modules are contemplated. The storage device 160 is connected to the system bus 110 by a drive interface. The drives and the associated computer readable storage media provide nonvolatile storage of computer readable instructions, data structures, program modules and other data for the computing device 100. In one aspect, a hardware module that performs a particular function includes the software component stored in a non-transitory computer-readable medium in connection with the necessary hardware components, such as the processor 120, bus 110, display 170, and so forth, to carry out the function. The basic components are known to those of skill in the art and appropriate variations are contemplated depending on the type of device, such as whether the device 100 is a small, handheld computing device, a desktop computer, or a computer server.

Although the exemplary embodiment described herein employs the hard disk 160, it should be appreciated by those skilled in the art that other types of computer readable media which can store data that are accessible by a computer, such as magnetic cassettes, flash memory cards, digital versatile disks, cartridges, random access memories (RAMs) 150, read only memory (ROM) 140, a cable or wireless signal containing a bit stream and the like, may also be used in the exemplary operating environment. Non-transitory computer-readable storage media expressly exclude media such as energy, carrier signals, electromagnetic waves, and signals per se.

To enable user interaction with the computing device 100, an input device 190 represents any number of input mechanisms, such as a microphone for speech, a touch-sensitive screen for gesture or graphical input, keyboard, mouse, motion input, speech and so forth. An output device 170 can also be one or more of a number of output mechanisms known to those of skill in the art. In some instances, multimodal systems enable a user to provide multiple types of input to communicate with the computing device 100. The communications interface 180 generally governs and manages the user input and system output. There is no restriction on operating on any particular hardware arrangement and therefore the basic features here may easily be substituted for improved hardware or firmware arrangements as they are developed.

For clarity of explanation, the illustrative system embodiment is presented as including individual functional blocks including functional blocks labeled as a “processor” or processor 120. The functions these blocks represent may be provided through the use of either shared or dedicated hardware, including, but not limited to, hardware capable of executing software and hardware, such as a processor 120, that is purpose-built to operate as an equivalent to software executing on a general purpose processor. For example the functions of one or more processors presented in FIG. 1 may be provided by a single shared processor or multiple processors. (Use of the term “processor” should not be construed to refer exclusively to hardware capable of executing software.) Illustrative embodiments may include microprocessor and/or digital signal processor (DSP) hardware, read-only memory (ROM) 140 for storing software performing the operations discussed below, and random access memory (RAM) 150 for storing results. Very large scale integration (VLSI) hardware embodiments, as well as custom VLSI circuitry in combination with a general purpose DSP circuit, may also be provided.

The logical operations of the various embodiments are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits. The system 100 shown in FIG. 1 can practice all or part of the recited methods, can be a part of the recited systems, and/or can operate according to instructions in the recited non-transitory computer-readable storage media. Such logical operations can be implemented as modules configured to control the processor 120 to perform particular functions according to the programming of the module. For example, FIG. 1 illustrates three modules Mod 1 162, Mod2 164 and Mod3 166 which are modules configured to control the processor 120. These modules may be stored on the storage device 160 and loaded into RAM 150 or memory 130 at =time or may be stored as would be known in the art in other computer-readable memory locations.

The principles disclosed herein can be used to correctly position and align mirrors, lenses, and other optical elements in an optical system such as a telescope. However, the application of these principles is more general and broad in digital sampling theory and in phase retrieval. One specific field of application is optics. Phase retrieval is a process for determining how well an optical system is performing. If the optical system has misaligned elements or if the optical system components have fabrication or manufacturing errors, phase retrieval can determine what these errors are without directly measuring the distances, angles, and alignments of optical system elements.

This approach is particularly useful in optical systems which are difficult to measure or access, such as a space-based telescope. Phase retrieval can provide information that the telescope is working properly after launch and deployment as well as determine the type, amount, and extent of other errors due to optical elements shifting during launch or due to other causes. The optical system can include control mechanisms providing for remote control of optical elements to correct for likely misalignments in the optical system.

Phase retrieval is a fundamentally different approach that does not require the use of an interferometer. In phase retrieval, the system retrieves an image, such as an image of a star through the telescope, and can use a phase retrieval algorithm to determine what is wrong with the optical system by analyzing how that star image looks. Phase retrieval means the recovery of optical errors. Any optical system can include optical errors. As an example, the human eye is an optical system. When the eye has optical errors, eyeglasses can correct those errors. If the eye is nearsighted, farsighted, or has astigmatism, an appropriately shaped eyeglasses lens helps the eye focus light back onto the retina. By recovering phase, the system recovers misalignments or other errors in an optical system that cause images received via the optical system to be blurred or degraded.

Manufacturers of camera lenses, telescopes, video surveillance equipment, and other optical equipment can benefit from this approach because each has a need to characterize how well an optical system is performing. Phase retrieval is an elegant and accurate way to characterize optical system performance without an interferometer. In some cases phase retrieval outperforms an interferometer.

Phase retrieval is based on a set of inputs. The accuracy of those inputs ultimately determines the accuracy of the phase to retrieve. The modulation transfer function (MTF) can perform phase retrieval directly from the image data observed through the optical system. For any image of a star, the system can retrieve the phase by calculating the modulation transfer function. The system can determine the parameters needed for phase retrieval via MTF, that can not be determined using other methods. This is a more accurate and direct approach because the parameters are calculated directly from the data and thus not tied to any misunderstandings about an optical model.

A user can open an image and click on a location in that image to view the signature for a desired parameter based on a calculation of the modulation transfer function. That parameter is called Q, or the ratio of the wavelength times the focal ratio divided by the pixel spacing. Image based retrieval can be used to characterize an optical system based on an accurate characterization system parameters such as pixel size, spacing, wavelength, focal ratio, and so forth. Rather than establishing an optical model to determine Q, which is prone to errors and misunderstanding based on differences between the expected and as-built optical system, the system can determine Q directly from the images generated by the optical system.

The system can determine Q based on an image by performing the following steps. The system collects images that are used as input to phase retrieval. The images can be intentionally defocused, such as a defocused image of a star, because a defocused image can expose more information about the optical system because it spreads the optical signal out over a greater number of pixels. This can expose characteristics of the optical system in a way that is not visible if the light was focused on just a few pixels. This is called a diversity function, or a known controlled apparition in the system. A phase map is an apparition, phase and apparition are synonymous and if you introduce an apparition or a phase term on purpose like introducing defocus, that's called a diversity function.

The system examines the image data and takes the Fourier transform of the image data called the optical transfer function (OTF). The absolute value of the OTF is called the modulation transfer function (MTF). If the MTF data is good enough and has sufficient signal and is not totally dominated by noise then the resulting image data usually includes a sharp ring or the cutoff frequency in the MTF. The system can use that cutoff frequency to calculate Q. If the data is noisy and the cutoff is not clear in the MTF, the system can boost the contrast of that image data via deconvolution to allow a user to see a crisper cutoff in the MTF. Because Q itself corresponds to the cutoff, if any of the other parameters are known, the focal ratio or the pixel size of the wavelength can be calculated. But in practice the system only needs to know Q to perform phase retrieval.

Having disclosed some basic system components and concepts, the disclosure now turns to the exemplary simple lens-based optical system shown in FIG. 2A and the exemplary simple mirror-based optical system shown in FIG. 2B. While these illustrative optical systems are simple and consist of a single optical element, such as a lens or a mirror, the principles disclosed herein are equally applicable to more complex optical systems having multiple optical elements. FIG. 2A illustrates an exemplary simple lens-based optical system 200. The optical system 200 produces an image 218 of an object 202 when rays of light 204, 206, 208 pass through a lens 210, prism, or other optical element. The lens 210 bends the rays of light 204, 206, 208 to produce an image 218 of the object 202. The manner in which the lens 210 bends the rays of light 204, 206, 208 can be defined by a set of focal points 214, 216 and a field angle 212. Similarly, FIG. 2B illustrates an exemplary simple mirror-based optical system. The optical system produces an image 234 of an object 220 when rays of light 222, 224, 226 reflect off a mirror 228 or other reflective optical element. The mirror 210 reflects the rays of light 222, 224, 226 to produce an image 234 of the object 220. The manner in which the mirror 228 reflects the rays of light 222, 224, 226 can be defined by a focal point 230 and a field angle 232. The principles described herein can be applied to more complex optical systems composed of multiple lenses, mirrors, and/or other optical elements.

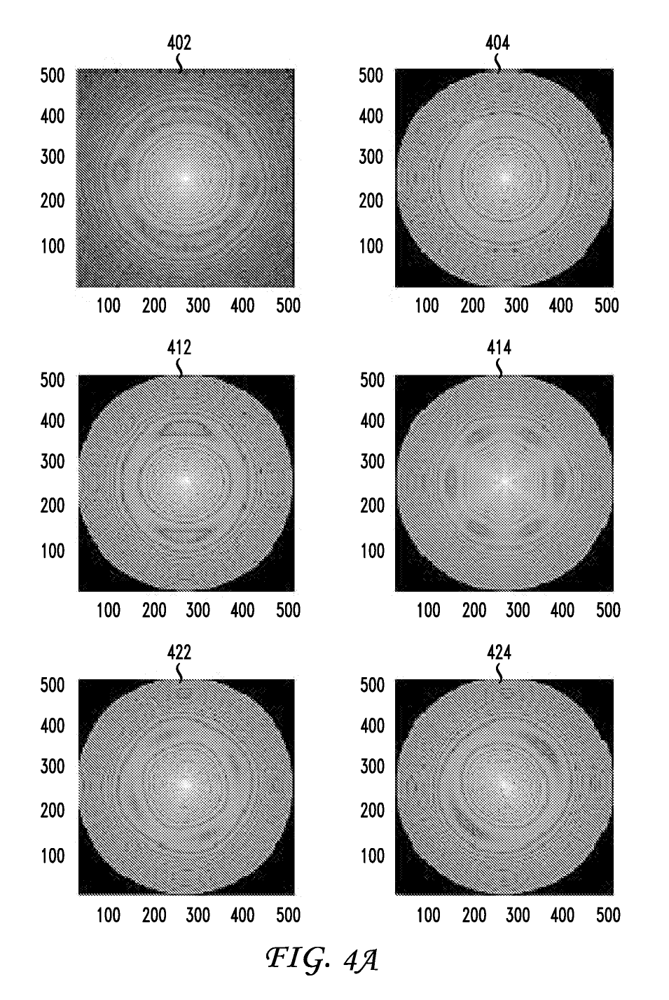

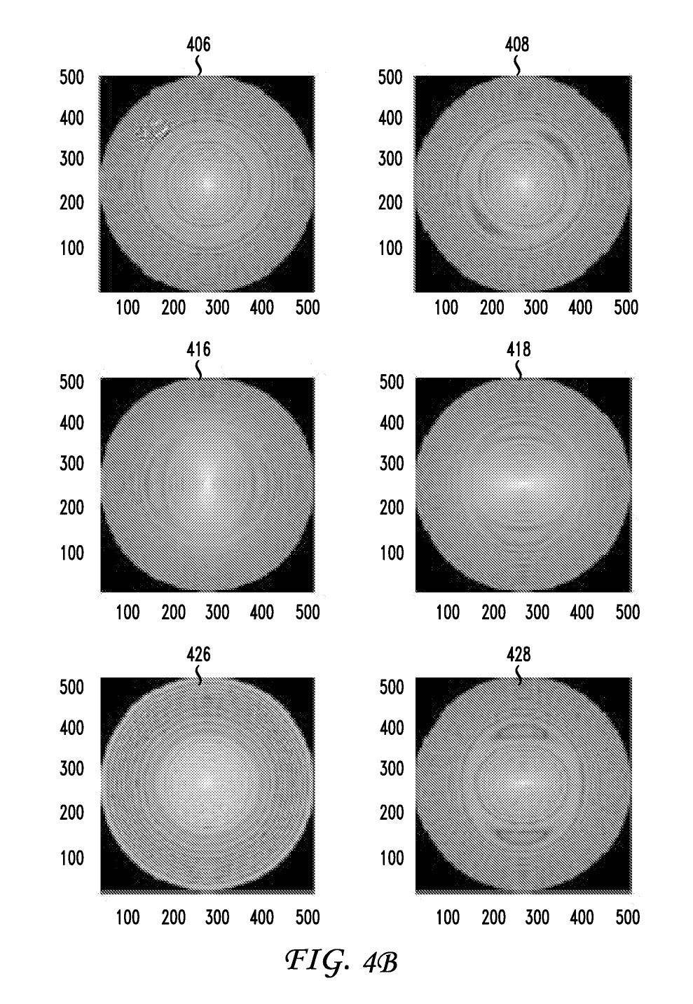

FIG. 3A illustrates first example image 300 received from an optical system and FIG. 3B illustrates a second example image 312 received from an optical system. The first example image 300 represents a remote object observed by the optical system. The image data includes aliased regions 302 emanating from a center point of the image 308. A user can select the aliased region by clicking on the edge of the aliased region's “ring” or clicking and dragging to the edge 310 of the aliased region 302. Alternately, the system can automatically detect the aliased region 302 with pattern recognition or other software.

Any optical system has a filter. For example, a modern digital camera has a certain size pixel in a charge-coupled device (CCD) array. If the camera images some scene onto that set of pixels, the camera is only able to capture high spatial frequency. Suppose the camera images a group of picket fences, each with a smaller spacing between the pickets than the last. As the pickets move closer and closer together, at some point the camera is unable to resolve a picket anymore. That is the maximum spatial frequency or MTF cutoff that the camera can resolve. The circle 306 corresponds to the maximum spatial frequency in image 300. Q is the ratio of the optical system cutoff frequency and the data sampling frequency which is essentially the inverse of the pixel size. This ratio determines the diameter of the circle 306. As a characteristic of this function at some point no further rings are visible.

In one embodiment, a software application loads the image and receives user input via a mouse click or other human interface device indicating the outer edge of the ring. The application automatically calculates Q based on the image data and the user input. Then the system and/or the user has a better understanding of the optical system prior to performing phase retrieval.

FIG. 3B illustrates a second example image 312 from an optical system. This image is a shifted to the side and up (or down) version of the image 300 in FIG. 3A. The image 300 in FIG. 3A places the object's image in the center, while image 312 places the centers of four objects' images in the four corners. The perspective in image 312 provides a more clear view of the intersection of the outer rings of the four objects' images as the diamond shaped region 314 in the middle of image 312. Image 312 includes four partially overlapping aliased regions 304. In one possible configuration, each aliased region corresponds to one optical element in an array of optical elements, such as a charge-coupled device (CCD) array.

In one aspect, the system divides image 300 into four quadrants: an upper right quadrant that covers 0 to 90 degrees, a lower right quadrant covering 90 to 180 degrees, a lower left quadrant covering 180 to 270 degrees, and an upper left quadrant covering 270 to 360 degrees. The system can rearrange the four quadrants to move the cutoff to the center of the array so that a user can more easily see the diamond shaped region 314. The diamond shaped region 314 is the zone past the cutoff frequency of the optical system.

The approach described herein can solve for data parameters, such as Q, describing the optical system directly from this image data. For example, the diameter of the modulation transfer function (MTF) defines the optical passband by 2*v_{b}, where v_{b} is the cut-off frequency or band limit. Once Q is determined, the system can perform phase retrieval for optical surfaces in an optical system down to a nanometer level. This information can then be used to adjust or align optical elements in an optical system for a clearer image.

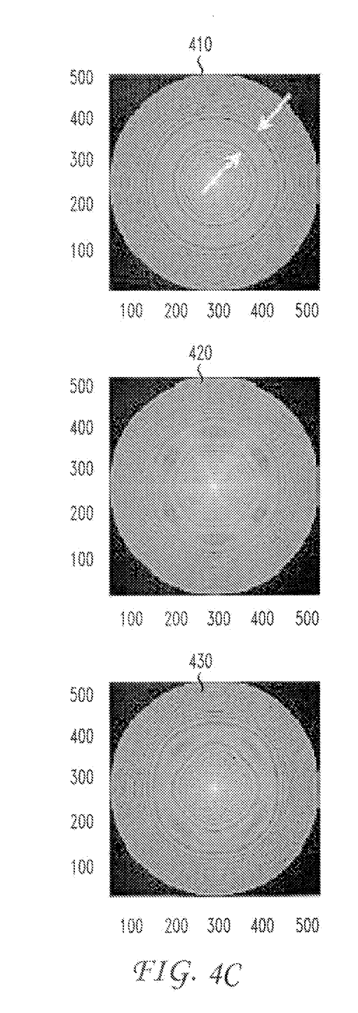

FIGS. 4A-4C illustrate a group of example images showing different phase retrieval results for various optical systems. Each individual image in FIGS. 4A-4C represents a different optical system configuration or a different alignment error. A user or an automatic software tool can analyze the various patterns in the images to determine the phase and optical characteristics of the system.

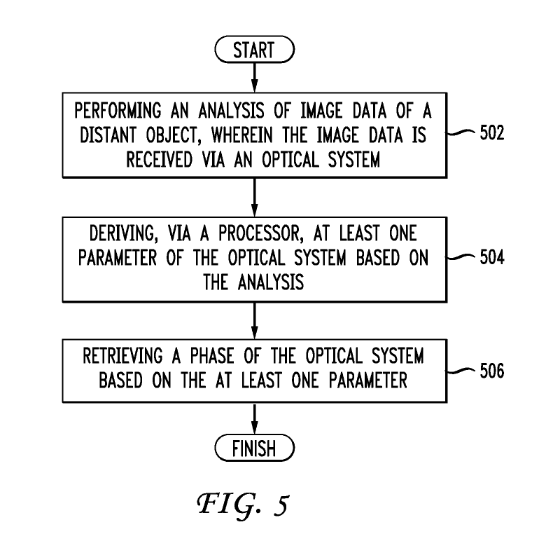

FIG. 5 illustrates an example method embodiment for determining phase of an optical system. For the sake of clarity, the method is discussed in terms of an exemplary system such as is shown in FIG. 1 configured to practice the method. The system 100 performs an analysis of image data of a distant object, wherein the image data is received via an optical system (502). In one aspect, the image data is a group of still images. The image data can be in focus and/or out of focus. In some cases, out of focus images can provide for a more informative analysis of the characteristics and phase of the optical system. The analysis of the image data can be based on user input, such as a mouse click or touch-screen input indicating a position and/or a region within the image data. The system 100 can alternatively enhance the image data's contrast via a deconvolution function to more clearly show the cutoff frequency.

The system 100 derives at least one parameter of the optical system based on the analysis (504). One image sampling parameter is the ratio Q, which is the ratio of the wavelength times the focal ratio, all divided by pixel spacing. Other parameters include the cutoff frequency, the data sampling frequency, and the plate scale.

The system 100 retrieves a phase of the optical system based on the at least one parameter (506). The system 100 can also derive at least one parameter of the optical system based on a diversity function. In one aspect, the system 100 generates an optical model based on an optical transfer function (OTF).

Embodiments within the scope of the present disclosure may also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor as discussed above. By way of example, and not limitation, such non-transitory computer-readable media can include RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those of skill in the art will appreciate that other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various embodiments described above are provided by way of illustration only and should not be construed to limit the scope of the disclosure. For example, the principles herein can be used to characterize optical system parameters so that accurate phase retrieval can be performed on the system. Errors in these parameters propagate to errors in the retrieved phase, and thus contribute to systematic error in applications involving control and metrology. Possible commercial applications of this approach are the same as applications for image-based phase retrieval, e.g., optical system control and optical system characterization and test. The principles disclosed herein can apply to any optical system, such as a telescope, microscope, binoculars, photographic lens, reflective surfaces, and combinations thereof. Those skilled in the art will readily recognize various modifications and changes that may be made to the principles described herein without following the example embodiments and applications illustrated and described herein, and without departing from the spirit and scope of the disclosure.

We claim:

1. A method of determining phase of an optical system, the method comprising:
performing an analysis of image data, received via an optical system, of a distant object;
deriving, via a processor, at least one parameter of the optical system based on the analysis; and
retrieving a phase of the optical system based on the at least one parameter.

2. The method of claim 1, further comprising modifying the optical system based on the phase.

3. The method of claim 1, wherein the at least one parameter is a ratio Q.

4. The method of claim 2, wherein Q is a ratio of wavelength times a focal ratio divided by pixel spacing.

5. The method of claim 1, wherein the analysis of the image data is based on a user input.

6. The method of claim 5, wherein the user input indicates a position in the image data.

7. The method of claim 5, wherein the user input indicates a region of the image data.

8. The method of claim 1, wherein the image data is in focus.

9. The method of claim 1, wherein the image data is out of focus.

10. The method of claim 9, the method further causing the computing device to derive the at least one parameter of the optical system based on a diversity function.

11. The method of claim 1, the method further causing the computing device to generate an optical model based on an optical transfer function.

12. The method of claim 1, the method further causing the computing device to enhance contrast of the image data by a deconvolution function.

13. The method of claim 12, wherein the image data is enhanced to more clearly show a cutoff frequency.

14. A system for determining phase of an optical system, the system comprising:
a processor;
a first module controlling the processor to perform an analysis of image data of a distant object, wherein the image data is received via an optical system;
a second module controlling the processor to derive, via a processor, at least one parameter of the optical system based on the analysis; and
a third module controlling the processor to retrieve a phase of the optical system based on the at least one parameter.

15. The system of claim 14, wherein the at least one parameter is a ratio Q.

16. The system of claim 15, wherein Q is a ratio of wavelength times a focal ratio divided by pixel spacing.

17. The system of claim 15, wherein the image data comprises a plurality of still images.

18. A non-transitory computer-readable storage medium storing instructions which, when executed by a computing device, cause the computing device to determine phase of an optical system, the instructions comprising:
performing an analysis of image data of a distant object, wherein the image data is received via an optical system;
deriving, via a processor, at least one parameter of the optical system based on the analysis; and
retrieving a phase of the optical system based on the at least one parameter.

19. The non-transitory computer-readable storage medium of claim 18, wherein the analysis of the image data is based on a user input.

20. The non-transitory computer-readable storage medium of claim 19, wherein the user input indicates a position in the image data.
